(19) United States
(12) Patent Application Publication
(10) Pub. No.: US 2005/0019730 A1
(43) Pub. Date: Jan. 27, 2005

(54) Dental minipin with interchangeable abutments

(76) Inventor: Neal B. Gittleman, Houston, TX (US)

Correspondence Address: Ezra L. Schacht, 1620 West Main St., Houston, TX, 77006-4712, US

(21) Appl. No.: 10/627,265

(22) Filed: Jul. 26, 2003

(51) Int. Cl. A61C 8/00

(52) U.S. Cl. 433/174

(57) ABSTRACT

A novel dental minipin implant fixture with detachable heads to accommodate either o-ring ball head retainers or a semi-permanently bonded overcase designed to replace a temporary denture. The dental practitioner can offer the economical choice of a removable acrylic denture to be replaced at a later date by a semi-permanently bonded porcelain prosthesis. Simply by changing the abutment head, the implanted minipin serves to anchor either choice of dental appliance.

### BACKGROUND OF THE INVENTION

Dental implants, acting primarily as a replacement for the root portion of the tooth, should rely upon a minimally invasive anchoring procedure while offering the strongest bond possible within the underlying bone. Present methods rely upon drilling a cylindrical bore of desired depth and setting by means of spiral threads, slip-fit or press-fit a cylindrical implant, usually of more than two millimeters in diameter. This surgical osteotomy procedure requires the resection of the soft tissue and the preparation of the bony ridge of the jaw for hole boring. The implant fixture is installed, a healing cap is fitted to the implant and the gum sutured. Time must be allowed for new bone to grow into recesses on the implant before any chewing pressure can be applied. Often, through disuse, the bony ridge has resorbed not leaving enough structural bone to properly secure a standard wide diameter implant fixture. Removable dentures are often the remedial and financial choice of the dental patient. The intermediate (and less costly) solution involves the use of anchoring minipins.

The minipins are not asked to carry the full occlusal pressure of the forces transmitted through the denture, but serve to stop lateral shifting and vertical lifting. Even the best conformal fit between the appliance undercase and the edentulous ridge does not necessarily prevent lateral motions that interfere with speech and mastication.

Recently, the Food and Drug Administration has approved for temporary stabilization the use of titanium alloy miniature dental implants or minipins having a diameter of less than 2 mm for the “provisional” attachment of dentures. These minipins are secured within the jaw without the resection of gum tissue or an extended healing time. In fact, dental practitioners have secured several of these pins within the jaw and modified the denture undercase with appropriate hardware to mate with the distal end of these minipins in one chair sitting. Semi-permanent cement or daily removable snap fittings have been tried with varying success. It is the object of this invention to detail an improved method and apparatus for the frequently secured and removed denture, while also offering the option of having a semi-permanent mounting at a later date. A primary objective of this invention is to provide a set of alternate abutment types mountable to mini-pin dental implant fixtures to meet the need for permanently bonded and demountable abutments. Often the removable denture can be replaced with a semi-permanently bonded prosthesis by replacing the removable hemispherical ball-head abutment with a cemented conical abutment.

The method of installation of a minipin implant involves these steps. Radiographic data on bone depth and thickness are used to determine optimum minipin implant length. A local anesthetic is infiltrated into the soft tissue at the site. A small hole of 1 mm or so is drilled through the soft tissue and cortical bone while externally irrigating with water. The hole formed is less than the external thread diameter and allows for the tapping by the minipin implant's self-starting threads. The implant is set to the intended depth with a suitable wrench. The wrench should be limited to a maximum torque to avoid damage to the minipin implant. An existing or newly fabricated prosthesis is lined with a fast setting, flexible-when-cured, polymer compound and placed over the newly installed minipin ballhead. Upon setting-up the flexible polymer forms sockets that can be snapped on and off the minipin head at will.

### BRIEF DESCRIPTION OF THE DRAWINGS

FIG. 1 gives a perspective view of a minipin with two detachable heads;

FIG. 2 is a perspective view of a minipin with alternative detachable extended heads;

FIG. 3 shows a perspective view of a minipin extended abutment with o-ring snap groove;

FIG. 4 is a perspective view of a prolate spheroidal head minipin dental implant with adjustment flats and o-ring groove; and

FIG. 5 is a minipin implant with detachable offset head.

### DETAILED DESCRIPTION OF THE DRAWINGS

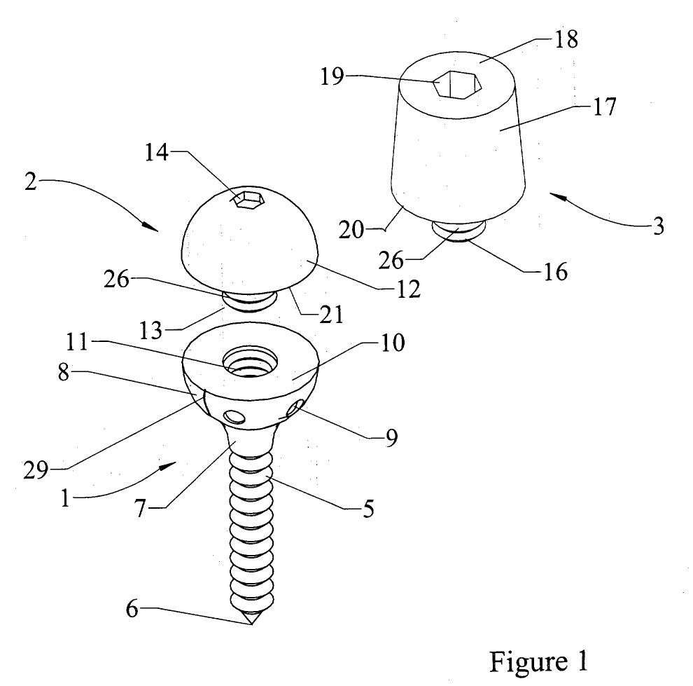

FIG. 1 shows a perspective exploded view of a minipin with two types of removable abutments. Minipin 1 has a self-starting threaded shaft 5 with a pointed, piercing end 6. A flared region 7 extends through the soft tissue region upward and in smooth transition with a hemispherical head 8. The upper circular face 10 has an internally threaded blind hole 11. Indents or flats 9 form detents to accommodate a wrench for driving or holding the minipin in place are located at multiple points around the circumference of the hemispherical head 8. The minipin 1 is fabricated by known machining methods as a single piece from a high strength titanium alloy. Typically, a spanner wrench with projections that mate with the indents on the minipin hemispherical head can be used to hold or turn the implant as desired. A thin walled socket wrench can mate with a series of flats formed on the hemispherical surface 8 of the minipin to drive in or remove the minipin.

A detachable hemispherical top 2 has a threaded shaft 13 which mates with threaded hole 11 and projects from a flat, circular face 21. The last thread 26 located next to face 21 can be of the interference type having a locking action when engaged with the top threads of blind hole 11 in the minipin. Hemispherical surface 12 has a smooth transition with surface 8 forming a ball head when threads of shaft 13 and hole 11 are fully engaged. Hexagonal driving recess 14 provides a means to drive the assembly into the underlying bone. The ball head formed mates with an o-ring fixture cemented within the undercasement of a denture. A number of these ball headed minipins are used to secure a full prosthetic arch. The denture is seated with gentle force, snapping the o-rings in their retainers over the ball heads. Alternatively, a denture soft liner of a durable, flexible silicone or polymer resin is cast in place over the ball heads to form snap fitting sockets having a flexible lip.

Truncated conic abutment 3 attaches to minipin 1 in place of the hemispherical section when a semi-permanent cemented prosthesis is desired. The conic abutment 3 can be used with a single crown or as one of multiple supports for a bridging prosthesis. The conic abutment 3 has a lower threaded shaft 16 projecting from underface 20. The last thread 26 located next to under face 20 can be of the interference type have a locking action when engaged with the top threads of blind hole 11 in the minipin. A registration mark 29 on the hemispherical surface 8 marks the start of the thread. The conic surface 17 mates smoothly with hemispherical head 8 of the minipin. Hexagonal drive hole 19 in surface 18 provides a means to engage the conic abutment to the minipin. When locking down any of the abutments, the minipin 1 is prevented from moving within the underlying bone. A wrench engages detents or flats 9 to prevent rotation of the minipin while installing the abutment. The minipin implant and the abutment form a rigid anchor for the overlying prosthesis.

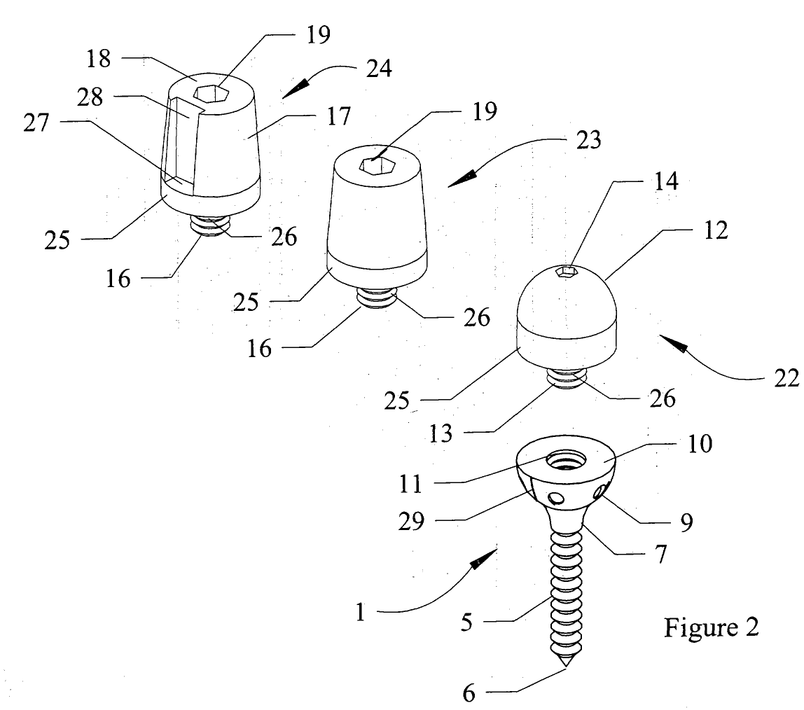

FIG. 2 shows additional abutments with extension regions 25 to accommodate differing soft tissue depths because of uneven bone recession in the dental arch. The intention is to place the distal ends of all the abutments at even heights within a sub-occlusal plane. This aids in the ease of placement of removable dentures over the minipin heads. The even loading of forces are best served by burying each minipin to a fully seated depth with the narrow portion of the threaded shaft 5 and some portion of flared region 7. In some cases, leaving an unburied narrow portion of the shaft above the bone could lead to minipin distortion or bending. The flared region 7 gives protection against occlusal pressure driving the implant further into the bone than is desired and provides a soft tissue emergence profile closer to a natural tooth. Nominally the diameter of the threaded portion of the minipin is 2 mm. The ball head diameter is 4 to 5 mm to form a good seat with the sockets molded in the soft liner polymer.

Minipins will be offered with varying lengths of threaded shaft 5 to penetrate to intended depths in the bone and no further. The portion of the shaft buried in the bone can have a surface treatment to encourage intimate growth of structural bone.

Abutments 22, 23 and 24 are designed to mate with minipin 1. Abutment 22 is shown in FIG. 2 with a cylindrical extended region 25 in smooth transition with hemispherical surface 12 of the ball head. Conic abutments 23 and 24 are shown with extension regions 25. This aids in placing the tops of the abutments 18 in the same sub-occlusal plane for proper loading and support of the prosthetic restoration. Abutment 24 has a machined groove 28 with an essentially flat floor 27 to serve as a hydrostatic relief groove where the application of semi-permanent cementing is desired. The shelf or floor 27 forms a gap or window with the matching prosthesis undercase. This gap or window allows the insertion of a parting or prying tool to effect the easy removal of the prosthesis without placing undue stress upon the minipin and bone juncture. The machined thread 13 on each of these abutment types has a thread portion 26 that is designed to form an interference fit with the top thread of blind hole 11 in such a manner as to lock in place the abutment. In particular, the grooved abutment 24 has a thread 16 manufactured to mate with the mounting hole 11 in order that the groove 28 is situated over the index mark 29 on the minipin. This identifying mark 29 is placed on the periphery of the hemispherical head 8 of the minipin. In the manufacturing process, thread 11 is always started in such a manner to allow the proper clocking of the external and internal threads so that the groove 28 can be placed cosmetically on the lingual face of the minipin. Sterile prepackaged kits of abutments with varying extension lengths are offered to mate with the minipin.

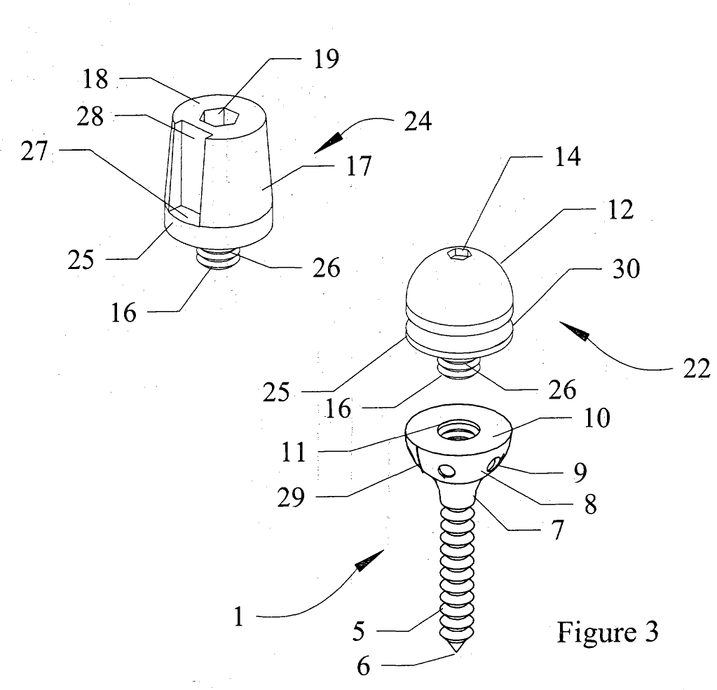

FIG. 3 shows a minipin implant with two embodiments of extended abutments. The hemispherical abutment 22 with extension region 25 is equipped with o-ring retention groove 30. In those cases where several millimeters of extension are needed, the o-ring retention assembly or the cast-in-place soft liner need not be forced the complete distance to the flared region 7 to form a positive snap connection. The o-ring or soft liner cast-in-place lip is forced over the hemispherical surface 12 and into groove 30.

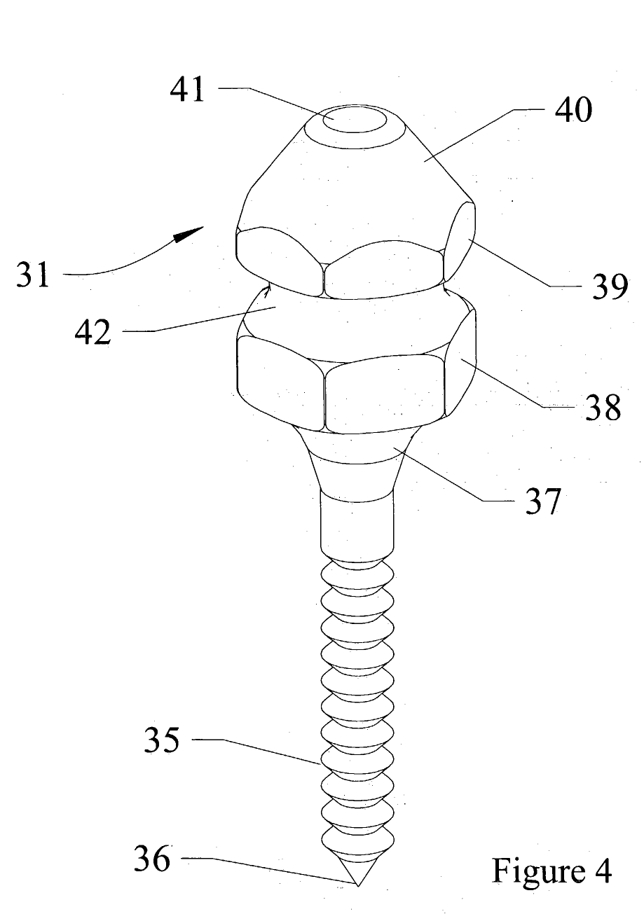

FIG. 4 shows an alternate embodiment of the minipin 31 with proximal pointed end 36 of spiral threaded shaft 35 with attached flared region 37 and cylindrical region with flats 38 for ease of installation and removal with a thin walled socket wrench. Similar flats 39 on the periphery of curved surface 40 aid in installation. Groove 42 will form a positive snap retention with either an o-ring assembly or mold-in-place soft polymer liner. Rounded distal end 41 aids in guiding the minipin into the mating molded socket or o-ring assembly. The upper portion of the minipin can be detached from the lower portion of the minipin by threaded means described in earlier embodiments of the invention. The region having flats 38 can be manufactured in various discrete heights to insure that distal end 41 is located in the sub-occlusal plane when the threaded shaft 35 is seated at the proper depth in the underlying bone. The minipin shown in this embodiment can be manufactured as a single continuous piece. The portion of the minipin assembly from the flared region 37 to the distal end 41 can be described as approximating a prolate spheroidal head (football shaped) having a circumferential o-ring or cast-in-place polymer groove 42 and driving and holding flats 38 and 39. Distal end 41 of the prolate spheroidal head can have a shaped recess to accommodate a driving or holding wrench such as an Allen wrench.

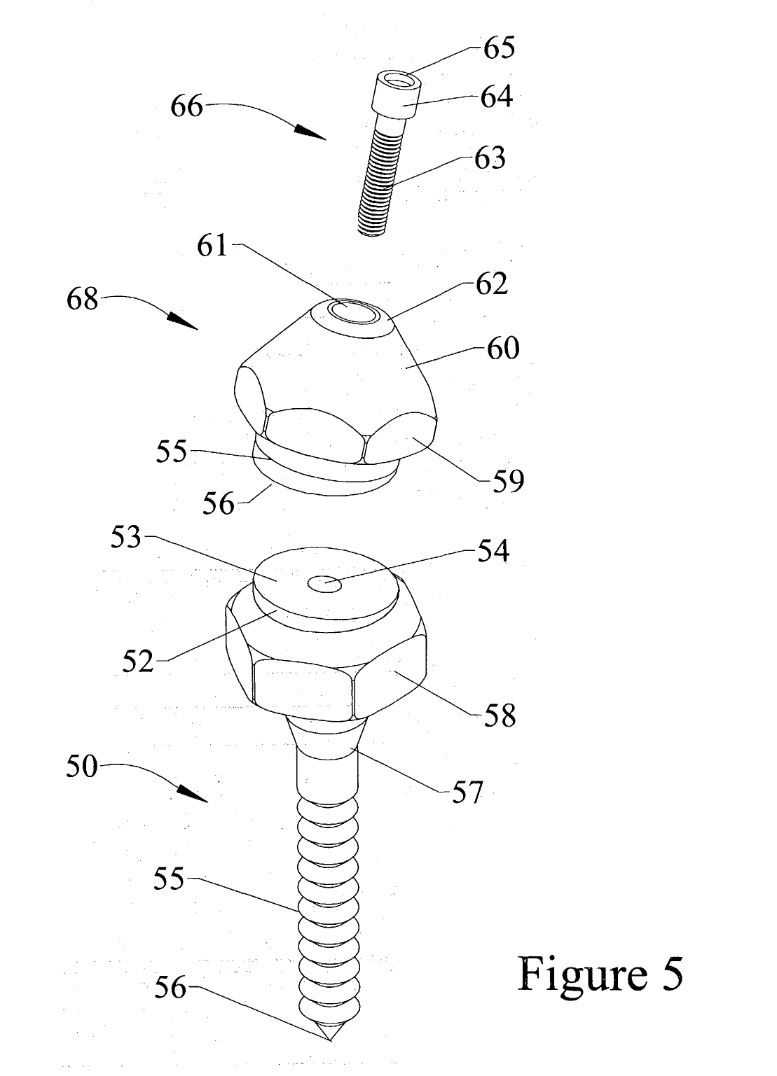

FIG. 5 is a perspective exploded view of a minipin dental implant 50 with an angled detachable abutment 68 secured by means of screw 66. The minipin dental implant 50 has a threaded shaft 55 with self-tapping proximal end 56 for securing in the underlying bone. Flared region 57 expands into a head with flats 58. Necked-in area 52 has an upper surface 53 set at a non-orthogonal angle to the major axis of the implant. Angled abutment 68 has a matching angled flat undersurface 56 and a necked-in region 55. Abutment 68 and implant 50 are mated and secured by means of screw 66 to form an angled assembly. This best suits anterior implant sites requiring deep anchorage in bone oblique to the sub-occlusal plane. Necked-in regions 52 and 55 form a groove for an o-ring assembly or cast-in-place flexible elastomeric polymer. Tapered region 60 terminates in a distal end 62 with a through-hole 61 having an internal countersink (not shown). Flats 59 aid in assembly. Screw 66 having thread 63 and cylindrical head 64 with driving recess 65 holds the abutment in place. Thread 63 mates with blind threaded hole 54. A portion of screw thread 63 can have a locking means to secure the screw in the blind hole.

1. A minipin dental implant apparatus to secure a prosthesis comprising a threaded shaft with a flared transition to a hemispherical head;
said hemispherical head having an upper circular face with a central threaded blind hole;
a detachable abutment having a circular face having a projecting abutment threaded shaft, said abutment threaded shaft mating with said threaded blind hole in said implant hemispherical head to form an anchor for an overlying prosthesis.

2. A minipin dental implant apparatus, as recited in claim 1, comprising a threaded shaft with a flared transition to a hemispherical head;
said hemispherical head having a circular face with a central threaded blind hole;
a detachable hemispherical abutment having a circular face having a projecting abutment threaded shaft, said abutment threaded shaft mating with said threaded blind hole in said minipin dental implant hemispherical head to form a spherical ball head to form an anchor for an overlying prosthesis.

3. A minipin dental implant, as recited in claim 1, comprising a threaded shaft with a flared transition to a hemispherical head;
said hemispherical head having a circular flat face with a central threaded blind hole;
a detachable conical abutment having a circular face having a projecting abutment threaded shaft, said abutment threaded shaft mating with said threaded blind hole to form a truncated cone head.

4. A minipin dental implant as recited in claim 1, comprising a number of detents located in the surface of said hemispherical head to accommodate a driving and holding wrench.

5. A minipin dental implant as recited in claim 1, comprising a self-starting thread on said threaded shaft.

6. A minipin dental implant apparatus as recited in claim 1, comprising said detachable hemispherical abutment having an elongated cylindrical extension region to accommodate differing tissue and bone depths.

7. A minipin dental implant apparatus as recited in claim 1, comprising said detachable truncated conic abutment having an elongated cylindrical extension region to accommodate differing tissue and bone depths.

8. A minipin dental implant apparatus as recited in claim 1, comprising said detachable hemispherical abutment having an elongated cylindrical region having an o-ring retention groove.

9. A minipin dental implant apparatus as recited in claim 1, comprising said detachable truncated conic abutment having a hydrostatic relief groove with a substantially flat floor to relieve pressure while cementing prosthesis in place and to provide a window for applying a prying force to remove said prostheses.

10. A minipin dental implant apparatus as recited in claim 1, comprising said minipin implant and said detachable abutment with locking thread means.

11. A minipin dental implant apparatus as recited in claim 1, comprising said detachable abutment with a driving recess for mating said projecting abutment threaded shaft with said minipin implant said threaded blind hole.

12. A minipin dental implant apparatus comprising a threaded shaft with a flared transition to a prolate spheroidal head;
said prolate spheroidal head having a circumferential groove to catch and mate with a flexible lip to form an anchor for an overlying prosthesis.

13. A minipin dental implant as recited in claim 12, comprising flats in the surface of said prolate spheroidal head for a driving and holding wrench.

14. A minipin dental implant as recited in claim 12, comprising a shaped recess in the distal end of said prolate spheroidal head for a driving or holding wrench.

15. A minipin dental implant as recited in claim 1, comprising an offset detachable abutment.

16. A minipin dental implant as recited in claim 12, comprising an offset detachable abutment.
